(19) United States
(12) Patent Application Publication
(10) Pub. No.: US 2024/0104901 A1
(43) Pub. Date: Mar. 28, 2024

(54) APPARATUS FOR SELECTING A TRAINING IMAGE OF A DEEP LEARNING MODEL AND A METHOD THEREOF

(71) Applicants: HYUNDAI MOTOR COMPANY, Seoul (KR); KIA CORPORATION, Seoul (KR)

(72) Inventors: Jin Sol Kim, Hwaseong-si (KR); Jin Ho Park, Seoul (KR)

(73) Assignees: HYUNDAI MOTOR COMPANY, Seoul (KR); KIA CORPORATION, Seoul (KR)

(21) Appl. No.: 18/096,905

(22) Filed: Jan. 13, 2023

(30) Foreign Application Priority Data
Sep. 28, 2022 (KR) 10-2022-0123600

(51) Int. Cl. G06V 10/774; G06V 10/74; G06V 10/75; G06V 10/776; G06V 10/82

(52) U.S. Cl. CPC G06V 10/774; G06V 10/759; G06V 10/761; G06V 10/776; G06V 10/82

(57) ABSTRACT

An apparatus for selecting a training image of a deep learning model and a method thereof are disclosed. The apparatus includes an input device and a controller. The input device receives a simulation image and information about an object in the simulation image from a simulation tool and receives a training image corresponding to the simulation image from an image conversion device. The controller detects a similarity between a structure of the object in the simulation image and a structure of an object in the training image and determines validity of the training image based on the detected similarity.

### CROSS-REFERENCE TO RELATED APPLICATION

This application claims the benefit of priority to Korean Patent Application No. 10-2022-0123600, filed in the Korean Intellectual Property Office on Sep. 28, 2022, the entire contents of which are incorporated herein by reference.

### TECHNICAL FIELD

The present disclosure relates to a technology for selecting an image (e.g., autonomous driving image data) used for learning a deep learning model.

### BACKGROUND

In general, an artificial neural network (ANN), which is a field of artificial intelligence, is an algorithm for allowing a machine to learn by simulating a human neural structure. Recently, artificial neural network technology has been applied to image recognition, speech recognition, natural language processing, and the like, and has shown excellent effects. An artificial neural network includes an input layer that receives an input, a hidden layer that learns, and an output layer that returns the result of an operation. The artificial neural network including the plurality of hidden layers is called a deep neural network (DNN), which is also a kind of artificial neural network.

An artificial neural network allows a computer to learn by itself based on data. When trying to solve a problem using an artificial neural network, it is necessary to prepare a suitable artificial neural network model and data to be analyzed. An artificial neural network model to solve a problem is trained based on data. Before training the model, it is necessary to first divide the data into two types. In other words, the data should be divided into a training dataset and a validation dataset. The training dataset is used to train the model. The validation dataset is used to verify the performance of the model.

There are various reasons for validating an artificial neural network model. An artificial neural network developer tunes the model by modifying the hyperparameters of a model based on the verification result of the model. In addition, the model verification is performed to select a suitable model from various models. The reason why the model verification is necessary is explained in more detail below.

The first reason is to predict accuracy. As a result, the purpose of artificial neural networks is to achieve good performance on out-of-sample data not used for training. Therefore, after creating the model, it is essential to check how well the model will perform on out-of-sample data. However, because the model should not be verified using the training dataset, the accuracy of the model should be measured using the validation dataset separated from the training dataset.

The second reason is to increase the performance of the model by tuning the model. For example, it is possible to prevent overfitting. Overfitting means that the model is over-trained on the training dataset. For example, when the training accuracy is high, but the validation accuracy is low, the occurrence of overfitting may be suspected. In addition, it may be understood in more detail through training loss and validation loss. When overfitting occurs, it is necessary to prevent overfitting to increase the validation accuracy. It is possible to prevent overfitting by using a scheme such as regularization or dropout.

Meanwhile, the performance of the deep learning model used for image recognition in an autonomous vehicle is directly related to the safety of an occupant. Therefore, a simulation image is generated using a simulation tool. The simulation image is converted to be like a live-action image. When the deep learning model is trained based on the converted simulation image, a change (disappearance of an object or the like) may occur in an object in the simulation image in the process of converting the simulation image to be like a live-action image.

For example, in the process of generating a simulation image (synthetic image), the simulation tool generates object information (e.g., label information of an object) in the simulation image together. However, when the object is lost in the process of converting the simulation image to be like a live-action image, label information of the object exists, but the object does not exist in the converted simulation image. As a result, when the deep learning model is trained based on the converted simulation image and the label information of the object, the performance of the deep learning model may be degraded.

Accordingly, the process of filtering training image data that degrades the performance of a deep learning model may accompany deep learning.

The subject matter described in this background section are intended to promote an understanding of the background of the disclosure and may include subject matter that is not already known to those of ordinary skill in the art.

### SUMMARY

The present disclosure has been made to solve the above-mentioned problems occurring in the prior art while advantages achieved by the prior art are maintained intact.

An aspect of the present disclosure provides an apparatus for selecting a training image of a deep learning model and a method thereof. The apparatus and method can detect a similarity between structures of an object in a simulation image and a structure of an object in a training image corresponding to the simulation image. The apparatus and method can also determine the validity of the training image based on the detected similarity. Thus, the training image can be prevented in advance from being used for training the deep learning model when a change occurs in an object in the simulation image in the process of converting the simulation image into the training image of the deep learning model.

The technical problems to be solved by the present disclosure are not limited to the aforementioned problems. Any other technical problems not mentioned herein should be clearly understood from the following description by those having ordinary skill in the art to which the present disclosure pertains. Also, it should be understood that the objects and advantages of the present disclosure may be realized by the units and combinations thereof recited in the claims.

According to an aspect of the present disclosure, an apparatus for selecting a training image of a deep learning model includes an input device and a controller. The input device receives a simulation image and information about an object in the simulation image from a simulation tool and receives a training image corresponding to the simulation image from an image conversion device. The controller detects a similarity between a structure of the object in the simulation image and a structure of an object in the training image and determines validity of the training image based on the detected similarity.

According to an embodiment, the controller may determine that the training image is invalid when the detected similarity does not exceed a threshold value.

According to an embodiment, the controller may determine that the training image is valid and store the training image in a storage when the detected similarity exceeds a threshold value.

According to an embodiment, the controller may determine that the training image is invalid when similarities are detected in a plurality of objects and at least one of the similarities of the plurality of objects does not exceed a threshold value.

According to an embodiment, the controller may determine that the training image is valid and store the training image in a storage when similarities are detected in a plurality of objects and all the similarities of the plurality of objects exceed a threshold value.

According to an embodiment, the controller may determine a region of a first object in the simulation image and a region of a second object in the training image based on information on the object in the simulation image and may detect a structural similarity between the first object and the second object.

According to an embodiment, the controller may detect a similarity between the structure of the object in the simulation image and the structure of the object in the training image based on a structural similarity index measure (SSIM).

According to an embodiment, the controller may assign a weight to a structural comparison term of the SSIM.

According to an embodiment, the simulation tool may generate the simulation image based on various scenarios and generate information about objects in the simulation image.

According to an embodiment, the image conversion device may convert the simulation image into the training image based on a generative adversarial network (GAN).

According to another aspect of the present disclosure, a method of selecting a training image of a deep learning model includes receiving, by an input device, a simulation image and information about an object in the simulation image from a simulation tool. The method also includes receiving, by the input device, a training image corresponding to the simulation image from an image conversion device. The method further includes detecting, by a controller, a similarity between a structure of the object in the simulation image and a structure of an object in the training image. The method also includes determining, by the controller, validity of the training image based on the detected similarity.

According to an embodiment, the determining of the validity of the training image may include determining that the training image is invalid when the detected similarity does not exceed a threshold value.

According to an embodiment, the determining of the validity of the training image may include determining that the training image is valid and storing the training image in a storage when the detected similarity exceeds a threshold value.

According to an embodiment, the determining of the validity of the training image may include determining that the training image is invalid when similarities are detected in a plurality of objects and at least one of the similarities of the plurality of objects does not exceed a threshold value.

According to an embodiment, the determining of the validity of the training image may include determining that the training image is valid and storing the training image in a storage when similarities are detected in a plurality of objects and all the similarities of the plurality of objects exceed a threshold value.

According to an embodiment, the detecting of the similarity may include determining a region of a first object in the simulation image and a region of a second object in the training image based on information on the object in the simulation image and may include detecting a structural similarity between the first object and the second object.

According to an embodiment, the detecting of the similarity may include detecting a similarity between the structure of the object in the simulation image and the structure of the object in the training image based on a structural similarity index measure (SSIM).

According to an embodiment, the detecting of the similarity may include assigning a weight to a structural comparison term of the SSIM.

According to an embodiment, the receiving of the simulation image and the information about the object in the simulation image may include generating, by the simulation tool, the simulation image based on various scenarios and may include generating, by the simulation tool, information about objects in the simulation image.

According to an embodiment, the receiving of the training image may include converting, by the image conversion device, the simulation image into the training image based on a generative adversarial network (GAN).

### BRIEF DESCRIPTION OF THE DRAWINGS

The above and other objects, features, and advantages of the present disclosure should be more apparent from the following detailed description taken in conjunction with the accompanying drawings:

FIG. 1 is a block diagram illustrating a system for selecting a training image of a deep learning model according to an embodiment of the present disclosure;

FIG. 2 is a block diagram illustrating the operation of a simulation tool provided in a system for selecting a training image of a deep learning model according to an embodiment of the present disclosure;

FIG. 3 is a diagram illustrating definitions of terms used to describe the operation of an image conversion device provided in a system for selecting a training image of a deep learning model according to an embodiment of the present disclosure;

FIG. 4 is a diagram illustrating the operation of an image conversion device provided in a system for selecting a training image of a deep learning model according to an embodiment of the present disclosure;

FIG. 5 is a view illustrating a simulation image generated by a simulation tool provided in a system for selecting a training image of a deep learning model according to an embodiment of the present disclosure;

FIG. 6 is a view illustrating a training image that is a result of converting a simulation image to be like a live-action image by an image conversion device provided in a system for selecting a training image of a deep learning model according to an embodiment of the present disclosure;

FIG. 7 is a view illustrating a process in which a controller provided in the apparatus for selecting a training image of a deep learning model according to an embodiment of the present disclosure detects the similarity between the structure of the object in the simulation image and the structure of the object in the training image;

FIG. 8 is a flowchart illustrating a method of selecting a training image of a deep learning model according to an embodiment of the present disclosure; and

FIG. 9 is a block diagram illustrating a computing system for executing a method of selecting a training image of a deep learning model according to an embodiment of the present disclosure.

### DETAILED DESCRIPTION

Hereinafter, some embodiments of the present disclosure are described in detail with reference to the drawings. In adding the reference numerals to the components of each drawing, it should be noted that the identical or equivalent component is designated by the identical numeral even when they are displayed on other drawings. Further, in describing embodiments of the present disclosure, a detailed description of the related known configuration or function has been omitted when it is determined that it interferes with the understanding of embodiments of the present disclosure.

In describing the components of embodiments according to the present disclosure, terms such as “first,” “second,” “A,” “B,” “(a),” “(b),” and the like, may be used. These terms are merely intended to distinguish the components from other components. These terms do not limit the nature, order, or sequence of the components. Unless otherwise defined, all terms including technical and scientific terms used herein have the same meaning as commonly understood by one of ordinary skill in the art to which this disclosure belongs. It should be further understood that terms, such as those defined in commonly used dictionaries, should be interpreted as having a meaning that is consistent with their meaning in the context of the relevant art and should not be interpreted in an idealized or overly formal sense unless expressly so defined herein. When a component, device, element, or the like, of the present disclosure, is described as having a purpose or performing an operation, function, or the like, the component, device, or element should be considered herein as being “configured to” meet that purpose or to perform that operation or function.

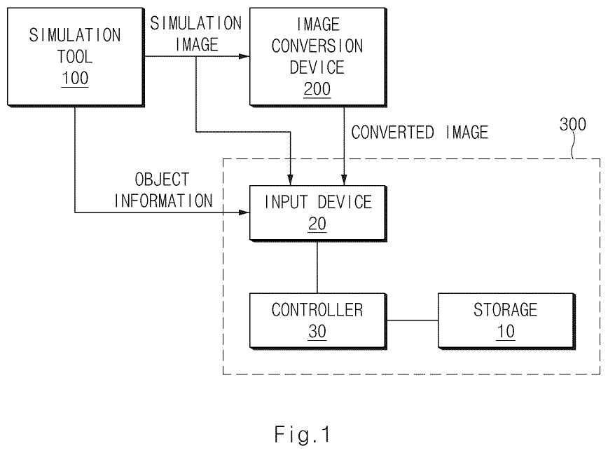

FIG. 1 is a block diagram illustrating a system for selecting a training image of a deep learning model according to an embodiment of the present disclosure.

As shown in FIG. 1, a system for selecting a training image of a deep learning model may include a simulation tool 100, an image conversion device 200, and a selection apparatus 300.

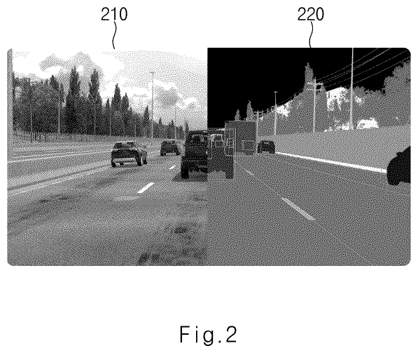

First, the simulation tool 100 may generate a simulation image based on various scenarios. The simulation tool 100 may also generate information (e.g., label information of an object) about objects in the simulation image together. Hereinafter, an operation of the simulation tool 100 is described with reference to FIG. 2.

FIG. 2 is a block diagram illustrating the operation of a simulation tool provided in a system for selecting a training image of a deep learning model according to an embodiment of the present disclosure.

As shown in FIG. 2, the simulation tool 100 provided in a system for selecting a training image of a deep learning model according to an embodiment of the present disclosure, which is a scenario for generating an image, may generate a simulation image such as reference numeral 210 when a situation is set in which a vehicle travels on a highway with many vehicles. In addition, as information on an object in the simulation image, segmentation for each object and label information 220 of a bounding box may be generated together.

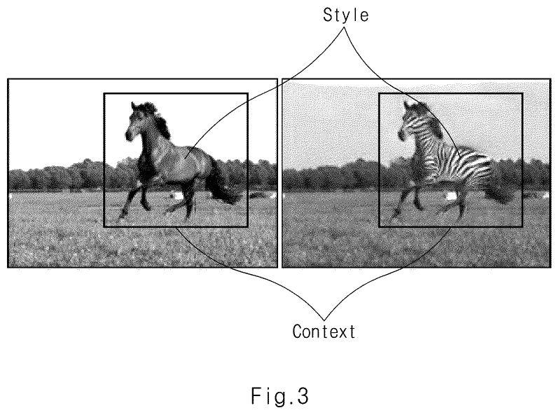

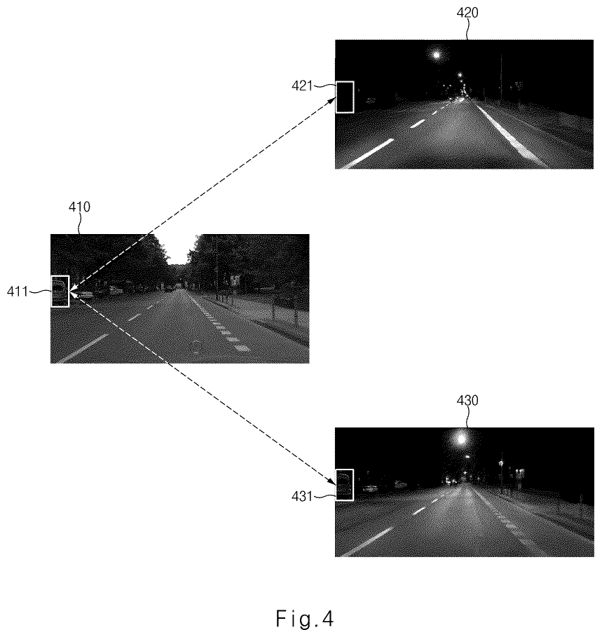

The image conversion device 200 may convert the simulation image generated by the simulation tool 100 into a training image. In other words, the image conversion device 200 may generate various training images by changing the style of an object in the simulation image based on a generative adversarial network (GAN). Hereinafter, an operation of the image conversion device 200 is described with reference to FIGS. 3 and 4.

FIG. 3 is a diagram illustrating definitions of terms used to describe the operation of an image conversion device provided in a system for selecting a training image of a deep learning model according to an embodiment of the present disclosure.

As shown in FIG. 3, a context indicates a minimum area including an object (e.g., a horse) in an image. A style collectively indicates the color and luminance, contrast, and structure of the object. In this case, the luminance refers to a quantity representing the brightness of light. The contrast refers to the degree to which the brightness of light in an image changes. The structure refers to the shape of an object created by pixels.

FIG. 4 is a diagram illustrating the operation of an image conversion device provided in a system for selecting a training image of a deep learning model according to an embodiment of the present disclosure.

As shown in FIG. 4, the image conversion device 200 provided in a system for selecting a training image of a deep learning model according to an embodiment of the present disclosure may convert a daytime road image 410 into a first night road image 420 or a second night road image 430.

It may be understood that an object 411 included in the daytime road image 410 is included in the second night road image 430 without disappearing in the process of being converted to the second night road image 430 as shown in reference numeral 431. However, in the process of converting the daytime road image 410 into the first night road image 420, it may be understood that the object 411 disappears as shown in reference numeral 421.

As described above, the object included in the simulation image may be lost in the process where the image conversion device 200 converts the simulation image into a training image. When such a training image is used for learning of a deep learning model, the performance of the deep learning model may be degraded.

Accordingly, the selection apparatus 300 according to an embodiment of the present disclosure may detect a similarity between structures of an object in a simulation image generated by the simulation tool 100 and a structure of an object in a training image converted by the image conversion device 200. The selection apparatus 300 may also determine the validity of the training image based on the detected similarity, such that it is possible to prevent the training image in advance from being used for training the deep learning model when a change (e.g., the loss of a part or all of an object) occurs in an object in the simulation image in the process of converting the simulation image into the training image of the deep learning model.

Hereinafter, the configuration of the apparatus 300 for selecting a training image of a deep learning model according to an embodiment of the present disclosure is described in detail.

As shown in FIG. 1, the apparatus 300 for selecting a training image of a deep learning model according to an embodiment of the present disclosure may include storage 10, an input device 20 and, a controller 30. In this case, depending on a scheme of implementing the apparatus 300 for selecting a training image of a deep learning model according to an embodiment of the present disclosure, components may be combined with each other to be implemented as one, or some components may be omitted.

Regarding each component, the storage 10 may store various logic, algorithms, and programs required in the processes of detecting a similarity between a structure of an object in a simulation image and a structure of an object in a training image corresponding to the simulation image and determining validity of the training image based on the detected similarity.

The storage 10 may store a structural similarity index measure (SSIM) algorithm used in the process of detecting the similarity between the structure of the object in the simulation image and the structure of the object in the training image corresponding to the simulation image.

The storage 10 may store the training image determined to be valid by the controller 30.

The storage 10 may include at least one type of a storage medium of memories of a flash memory type, a hard disk type, a micro type, a card type (e.g., a secure digital (SD) card or an extreme digital (XD) card, and the like). The storage 10 may also include a random-access memory (RAM), a static RAM, a read-only memory (ROM), a programmable ROM (PROM), an electrically-erasable PROM (EEPROM), a magnetoresistive RAM (MRAM), a magnetic disk, and an optical disk type memory.

The input device 20 may receive the simulation image and information (hereinafter, referred to as object information) about objects included in the simulation image from the simulation tool 100.

The input device 20 may receive a training image corresponding to the simulation image from the image conversion device 200.

The controller 30 may perform overall control such that each component performs its function. The controller 30 may be implemented in the form of hardware or software or may be implemented in a combination of hardware and software. The controller 30 may be implemented as a microprocessor but is not limited thereto.

Specifically, the controller 30 may perform various controls required in the process of detecting the similarity between the structure of the object in the simulation image and the structure of the object in the training image corresponding to the simulation image and the process of determining the validity of the training image based on the detected similarity.

The controller 30 may determine that the training image is invalid when the detected similarity does not exceed a threshold value. The controller 30 may determine that the training image is valid and store the training image in the storage 10 when the detected similarity exceeds the threshold value

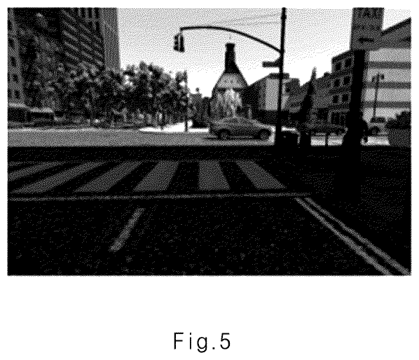

Hereinafter, the operation of the controller 30 is described in detail with reference to FIGS. 5-7.

FIG. 5 is a view illustrating a simulation image generated by a simulation tool provided in a system for selecting a training image of a deep learning model according to an embodiment of the present disclosure.

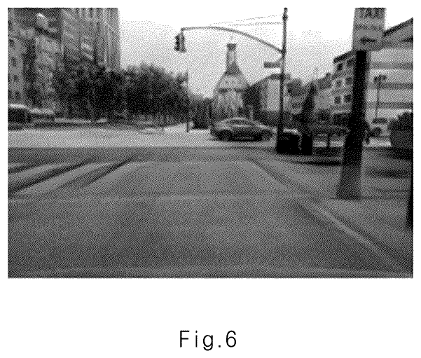

FIG. 6 is a view illustrating a training image that is a result of converting a simulation image to be like a live-action image by an image conversion device provided in a system for selecting a training image of a deep learning model according to an embodiment of the present disclosure.

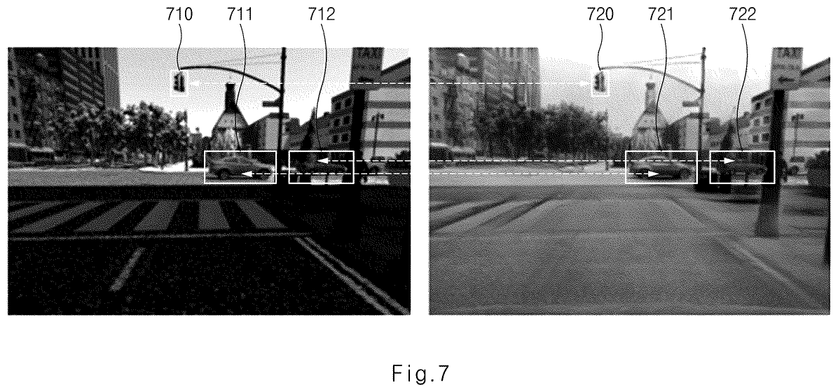

FIG. 7 is a view illustrating a process in which a controller provided in the apparatus for selecting a training image of a deep learning model according to an embodiment of the present disclosure detects the similarity between the structure of the object in the simulation image and the structure of the object in the training image.

As shown in FIG. 7, based on the object information received from the simulation tool 100, the controller 30 may determine the locations (region) of each object 710, 711, and 712 in the simulation image and the locations of each object 720, 721, and 722 in the training image. Accordingly, the controller 30 may detect the similarity of each object corresponding to the other.

For example, the controller 30 may detect the similarity between the structure of the object in the simulation image and the structure of the object in the training image based on a structural similarity index measure (SSIM) scheme. In other words, the controller 30 may detect the similarity between the structure of the object in the simulation image and the structure of the object in the training image by using the following Equation 1.

$$SSIM ( x , y ) = [ {l ( x , y )}^{α} * {c ( x , y )}^{β} * {s ( x , y )}^{γ} ] = {( \frac{2 {μ}_{x} {μ}_{y} + {c}_{1}}{{μ}_{x}^{2} + {μ}_{y}^{2} + {c}_{1}} )}^{α} {( \frac{2 {σ}_{x} {σ}_{y} + {c}_{2}}{{σ}_{x}^{2} + {σ}_{y}^{2} + {c}_{2}} )}^{β} ( \frac{{σ}_{xy} + {c}_{3}}{{σ}_{x} {σ}_{y} + {c}_{3}} ) \qquad [ Equation 1 ]$$

Win Equation 1, 1 means luminance, c means contrast, s means a structure, and α, β, and γ mean weights, respectively. Because the controller 30 is required to detect the similarity between the structure of the object in the simulation image x and the structure of the object in the training image y, a weight is assigned to only γ, or a higher weight than α and β is assigned to γ.

In addition, μₓ represents the average (luminance) of the brightness of each pixel in the simulation image x. Also, μ_{y} represents the average of the brightness of each pixel in the training image y. Further, σₓ represents the standard deviation of the brightness of each pixel in the simulation image x. Also, σ_{y} represents the standard deviation (contrast) of the brightness of each pixel in the training image y. Further, σ_{xy} represents the cross-covariance of the simulation image x and the training image y, and C1, C2, and C3 represent constants, respectively.

When at least one of the similarities for each object detected through Equation 1 does not exceed the threshold value, the controller 30 may determine that the training image is invalid. In this case, when all the similarities of the objects detected through Equation 1 exceed the threshold, the controller 30 may determine that the training image is valid and store the training image in the storage 10.

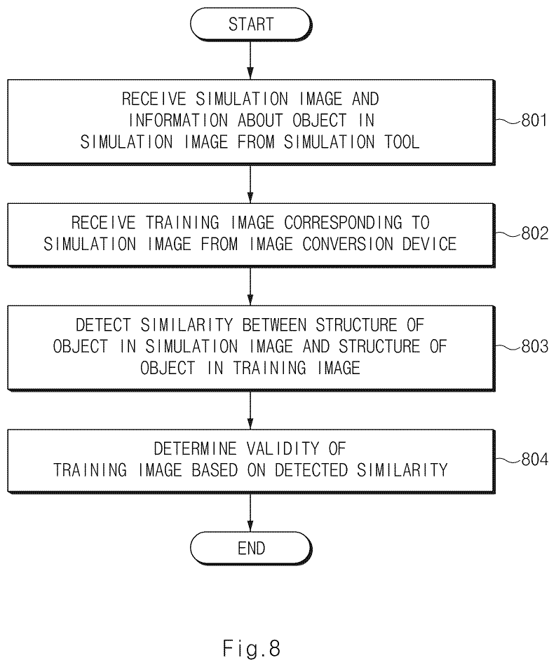

FIG. 8 is a flowchart illustrating a method of selecting a training image of a deep learning model according to an embodiment of the present disclosure.

First, in operation 801, the input device 20 receives a simulation image and information about an object in the simulation image from the simulation tool 100.

Then, in operation 802, the input device 20 receives a training image corresponding to the simulation image from the image conversion device 200.

Then, in operation 803, the controller 30 detects a similarity between the structure of the object in the simulation image and the structure of the object in the training image.

Then, in operation 804, the controller 30 determines the validity of the training image based on the detected similarity.

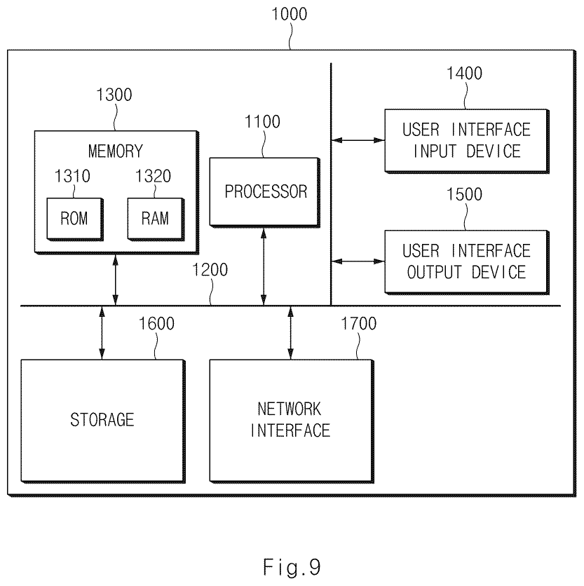

FIG. 9 is a block diagram illustrating a computing system for executing a method of selecting a training image of a deep learning model according to an embodiment of the present disclosure.

Referring to FIG. 9, a method of selecting a training image of a deep learning model according to an embodiment of the present disclosure described above may be implemented through a computing system. A computing system 1000 may include at least one processor 1100, a memory 1300, a user interface input device 1400, a user interface output device 1500, storage 1600, and a network interface 1700 connected through a system bus 1200.

The processor 1100 may be a central processing device (CPU) or a semiconductor device that processes instructions stored in the memory 1300 and/or the storage 1600. The memory 1300 and the storage 1600 may include various types of volatile or non-volatile storage media. For example, the memory 1300 may include a ROM 1310 and a RAM 1320.

Accordingly, the processes of the method or algorithm described in relation to embodiments of the present disclosure may be implemented directly by hardware executed by the processor 1100, a software module, or a combination thereof. The software module may reside in a storage medium (e.g., the memory 1300 and/or the storage 1600), such as a RAM, a flash memory, a ROM, an EPROM, an EEPROM, a register, a hard disk, solid-state drive (SSD), a detachable disk, or a compact disk ROM (CD-ROM). The storage medium is coupled to the processor 1100. The processor 1100 may read information from the storage medium and may write information in the storage medium. In another method, the storage medium may be integrated with the processor 1100. The processor and the storage medium may reside in an application-specific integrated circuit (ASIC). The ASIC may reside in a user terminal. In another method, the processor and the storage medium may reside in the user terminal together as an individual component.

As described above, the apparatus for selecting a training image of a deep learning model and a method thereof according to embodiments of the present disclosure may detect a similarity between structures of an object in a simulation image and a structure of an object in a training image corresponding to the simulation image. The apparatus for selecting a training image of a deep learning model and a method thereof may also determine the validity of the training image based on the detected similarity, so that it is possible to prevent the training image in advance from being used for training the deep learning model when a change occurs in an object in the simulation image in the process of converting the simulation image into the training image of the deep learning model.

Although embodiments of the present disclosure have been described for illustrative purposes, those having ordinary skill in the art should appreciate that various modifications, additions, and substitutions are possible, without departing from the scope and spirit of the disclosure.

Therefore, the embodiments described in the present disclosure are provided for the sake of descriptions not to limit the technical concepts of the present disclosure. It should be understood that such embodiments are not intended to limit the scope of the technical concepts of the present disclosure. The scope of protection of the present disclosure should be understood by the claims below. All the technical concepts within the equivalent scopes should be interpreted to be within the scope of the present disclosure.

What is claimed is:

1. An apparatus for selecting a training image of a deep learning model, the apparatus comprising:
an input device configured to
receive a simulation image and information about an object in the simulation image from a simulation tool, and
receive a training image corresponding to the simulation image from an image conversion device; and
a controller configured to
detect a similarity between a structure of the object in the simulation image and a structure of an object in the training image, and
determine validity of the training image based on the detected similarity.

2. The apparatus of claim 1, wherein the controller is configured to determine that the training image is invalid when the detected similarity does not exceed a threshold value.

3. The apparatus of claim 1, wherein the controller is configured to
determine that the training image is valid, and
store the training image in a storage when the detected similarity exceeds a threshold value.

4. The apparatus of claim 1, wherein the controller is configured to determine that the training image is invalid when
similarities are detected in a plurality of objects, and
at least one of the similarities of the plurality of objects does not exceed a threshold value.

5. The apparatus of claim 1, wherein the controller is configured to
determine that the training image is valid, and
store the training image in a storage when
similarities are detected in a plurality of objects, and
all the similarities of the plurality of objects exceed a threshold value.

6. The apparatus of claim 1, wherein the controller is configured to
determine a region of a first object in the simulation image and a region of a second object in the training image based on information on the object in the simulation image, and
detect a structural similarity between the first object and the second object.

7. The apparatus of claim 1, wherein the controller is configured to detect a similarity between the structure of the object in the simulation image and the structure of the object in the training image based on a structural similarity index measure (SSIM).

8. The apparatus of claim 7, wherein the controller is configured to assign a weight to a structural comparison term of the SSIM.

9. The apparatus of claim 1, wherein the simulation tool is configured to
generate the simulation image based on various scenarios, and
generate information about objects in the simulation image.

10. The apparatus of claim 1, wherein the image conversion device is configured to convert the simulation image into the training image based on a generative adversarial network (GAN).

11. A method of selecting a training image of a deep learning model, the method comprising:
receiving, by an input device, a simulation image and information about an object in the simulation image from a simulation tool;
receiving, by the input device, a training image corresponding to the simulation image from an image conversion device;
detecting, by a controller, a similarity between a structure of the object in the simulation image and a structure of an object in the training image; and
determining, by the controller, validity of the training image based on the detected similarity.

12. The method of claim 11, wherein the determining of the validity of the training image includes determining that the training image is invalid when the detected similarity does not exceed a threshold value.

13. The method of claim 11, wherein the determining of the validity of the training image includes
determining that the training image is valid, and
storing the training image in a storage when the detected similarity exceeds a threshold value.

14. The method of claim 11, wherein the determining of the validity of the training image includes determining that the training image is invalid when
similarities are detected in a plurality of objects and
at least one of the similarities of the plurality of objects does not exceed a threshold value.

15. The method of claim 11, wherein the determining of the validity of the training image includes
determining that the training image is valid, and
storing the training image in a storage when similarities are detected in a plurality of objects and all the similarities of the plurality of objects exceed a threshold value.

16. The method of claim 11, wherein the detecting of the similarity includes
determining a region of a first object in the simulation image and a region of a second object in the training image based on information on the object in the simulation image, and
detecting a structural similarity between the first object and the second object.

17. The method of claim 11, wherein the detecting of the similarity includes detecting a similarity between the structure of the object in the simulation image and the structure of the object in the training image based on a structural similarity index measure (SSIM).

18. The method of claim 17, wherein the detecting of the similarity includes assigning a weight to a structural comparison term of the SSIM.

19. The method of claim 11, wherein the receiving of the simulation image and the information about the object in the simulation image includes
generating, by the simulation tool, the simulation image based on various scenarios, and
generating, by the simulation tool, information about objects in the simulation image.

20. The method of claim 11, wherein the receiving of the training image includes converting, by the image conversion device, the simulation image into the training image based on a generative adversarial network (GAN).
